(19) United States
(12) Patent Application Publication
(10) Pub. No.: US 2026/0300360 A1
(43) Pub. Date: Oct. 1, 2026

(54) INPUT ASSISTANCE APPARATUS, INPUT ASSISTANCE METHOD, AND INPUT ASSISTANCE PROGRAM

(71) Applicant: NEC Corporation, Tokyo (JP)

(72) Inventors: Sianen OOI, Tokyo (JP); Masaharu MORIMOTO, Tokyo (JP); Yoshiaki SAKAE, Tokyo (JP); Masaki INOKUCHI, Tokyo (JP); Ryosuke HOTCHI, Tokyo (JP); Tatsuya FUKUDA, Tokyo (JP); Joe BRINTON, Tokyo (JP); Shunsuke OSAKI, Tokyo (JP)

(73) Assignee: NEC Corporation, Tokyo (JP)

(21) Appl. No.: 19/577,560

(22) Filed: Mar. 25, 2026

(30) Foreign Application Priority Data
Mar. 28, 2025 (JP) 2025-054992

(51) Int. Cl. G06F 16/335; G06F 16/34

(52) U.S. Cl. CPC G06F 16/337; G06F 16/345

(57) ABSTRACT

An input assistance apparatus including an evaluation unit configured to evaluate, using a second language model that is lighter than a first language model, a query candidate generated based on analysis results of input information indicating input from a user to a task assistance application built on the first language model and context information indicating a situation of the user, based on a degree of match with an intent of the user, and an output unit configured to output information indicating the query candidate and an evaluation result thereof.

### CROSS-REFERENCE TO RELATED APPLICATION

This application is based upon and claims the benefit of priority from the prior Japanese Patent Application No. 2025-054992, filed Mar. 28, 2025, the entire contents of which are incorporated herein by reference.

### BACKGROUND OF INVENTION

### Field of the Invention

The present disclosure relates to an input assistance apparatus, an input assistance method, and an input assistance program.

### Description of the Related Art

Patent literature 1 describes a technique for proposing, to a user during a query input process, an auto-completion string (a term or a phrase) for a query.
[Patent literature 1] U.S. Pat. No. 6,564,213

### SUMMARY OF INVENTION

In the technique described in Patent literature 1, based on partial input by a user, history data (query logs, frequency and popularity in a database, search context, and the like) is used to provide static and pattern-based prediction. However, in this technique, because broader context and a user intent behind the query are not considered, there is room for improving accuracy.

An example object of the present disclosure is to provide an input assistance apparatus, an input assistance method, and an input assistance program that can improve accuracy of input assistance.

An input assistance apparatus according to an example aspect of the present disclosure includes an evaluation unit configured to evaluate, using a second language model that is lighter than a first language model, a query candidate generated based on analysis results of input information indicating input from a user to a task assistance application built on the first language model and context information indicating a situation of the user, based on a degree of match with an intent of the user, and an output unit configured to output information indicating the query candidate and an evaluation result thereof.

An input assistance method according to an example aspect of the present disclosure includes evaluating, by a computer using a second language model that is lighter than a first language model, a query candidate generated based on analysis results of input information indicating input from a user to a task assistance application built on the first language model and context information indicating a situation of the user, based on a degree of match with an intent of the user, and outputting information indicating the query candidate and an evaluation result thereof.

An input assistance program according to an example aspect of the present disclosure causes a computer to execute evaluation processing for evaluating, using a second language model that is lighter than a first language model, a query candidate generated based on analysis results of input information indicating input from a user to a task assistance application built on the first language model and context information indicating a situation of the user, based on a degree of match with an intent of the user, and output processing for outputting information indicating the query candidate and an evaluation result thereof.

According to the present disclosure, accuracy of input assistance can be improved.

### BRIEF DESCRIPTION OF THE DRAWINGS

FIG. 1 It is a block diagram illustrating an example functional configuration of an input assistance apparatus.

FIG. 2 It is a flowchart illustrating example operation of the input assistance apparatus.

FIG. 3 It is a diagram illustrating an example operation overview of the input assistance apparatus.

FIG. 4 It is a diagram illustrating an example operation overview for multi-modal user input.

FIG. 5 It is a block diagram illustrating an example hardware configuration of a computer.

FIG. 6 It is a block diagram illustrating an example main part of the input assistance apparatus.

### DESCRIPTION OF THE PREFERRED EMBODIMENTS

While use of AI (Artificial Intelligence) support tools, in particular co-pilots and virtual assistants, is increasing, quality of input from a user is extremely important in order to generate an optimal response. However, typical input validation methods do not provide sufficient effectiveness, misunderstanding or inefficiency may occur, and frequent manual correction may be required. Users face various issues related to quality, clarity, relevance, and the like of input, and this can reduce productivity and accuracy in interaction with AI.

Typical input validation methods have two main issues, which are input quality and efficiency. From a viewpoint of input quality, because quality and relevance of information input by an end user to a co-pilot varies, an inappropriate or incorrect response may be generated. From a viewpoint of efficiency, non-optimized input may cause misunderstanding and may increase processing time and reduce overall efficiency.

Differences between a co-pilot or a virtual assistant and a large language model (LLM: Large Language Model) are explained.

A large language model is a general-purpose model that requires high computational cost as compared with a co-pilot or a virtual assistant. A large language model performs, for example, processing and generation of text or images based on a prompt input by a user. In order to obtain an accurate response from a large language model, high-quality input is required.

In contrast, a co-pilot or a virtual assistant is an application built on a large language model and is designed in such a way as to support a specific task. For example, it is designed as a task-oriented system that supports a user in a specific workflow, such as support in coding or in an integrated development environment (Integrated Development Environment, hereinafter referred to as an IDE), or a conversation agent for support.

Respective roles in a workflow are as follows. A large language model has a function of answering questions or generating content in accordance with a prompt, but does not inherently understand a user need or a way of organizing answers in a specific scenario. In contrast, a co-pilot or a virtual assistant uses context obtained from a user tool, such as text in an IDE or an active project file, and plays a more proactive role, such as making an inquiry to a large language model in a form suitable for the user need.

As a technique related to input assistance for a user, Patent literature 1 describes a technique for providing static and pattern-based prediction by using history data (query logs, frequency and popularity in a database, search context, and the like) based on partial input by a user. However, in this technique, broader context and a user intent behind the query are not considered. Further, because this technique focuses on assisting completion of a search query by proposing popular search strings or highly relevant search strings, it cannot optimize clarity or relevance of input beyond auto-completion.

Further, Literature 2 (U.S. Patent No. 8645825) describes a technique for making real-time proposals. However, this technique operates within a context of auto-completion based on pre-cached data or server requests, and does not perform dynamic interaction or optimization of the input itself. In addition, the approach of this technique focuses on presenting static proposals based on an n-gram (an n-length sequence of words or characters), and does not consider deep context awareness or iterative improvement of input.

The present disclosure has been made in view of the issues described above. One object of the present disclosure is to provide an input assistance apparatus, an input assistance method, and an input assistance program that can improve accuracy of input assistance.

In the following, example embodiments of the present disclosure are explained with reference to the drawings. In each drawing, the same or related elements are denoted by the same reference signs, and duplicated explanation may be omitted as needed for clarity of explanation. Unless otherwise stated, predetermined values such as a predetermined value or a threshold are stored in advance in a storage device or the like that is accessible from an apparatus that uses the values. Unless otherwise stated, a storage unit is configured by one or more storage devices in any number.

In an example embodiment of the present disclosure, a large language model represents an artificial intelligence model trained using text data and has an ability to execute tasks such as natural language processing. A large language model enables context-dependent generation and interpretation of text by using, for example, a neural network, in particular a transformer architecture. A large language model is not necessarily required to be large, and may be merely a language model. In addition, a large language model may be a model trained using image data. In the following, for convenience of explanation, such a language model having an ability to process language is referred to as a large language model (LLM).

### Example Embodiment 1

### Explanation of Configuration

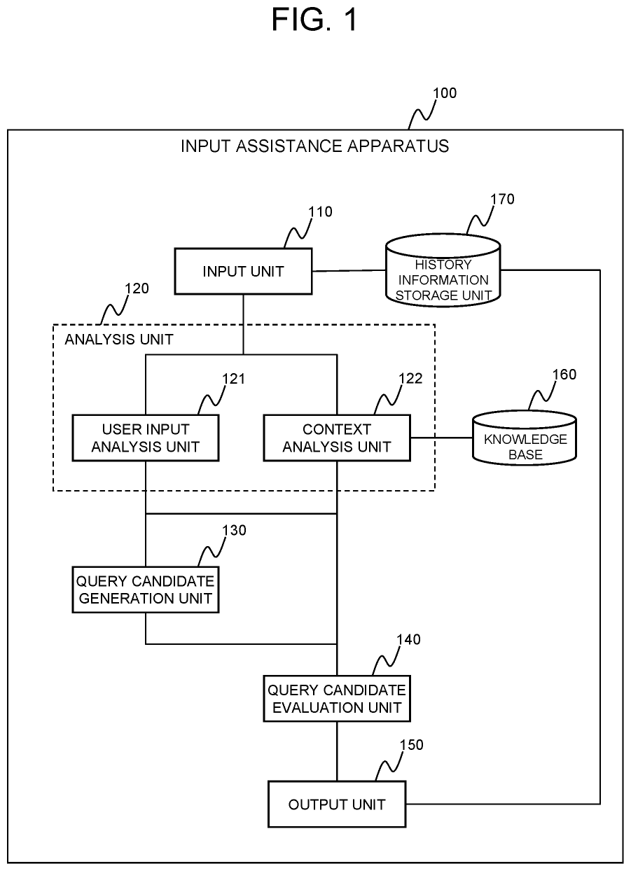

An input assistance apparatus according to the present example embodiment is explained. FIG. 1 is a block diagram illustrating an example functional configuration of the input assistance apparatus.

An input assistance apparatus 100 has a function of assisting input performed by a user to a task assistance application such as a co-pilot or a virtual assistant. A co-pilot or a virtual assistant is built on an LLM (hereinafter also referred to as a first LLM or a first language model). The input assistance apparatus 100 is configured to be capable of executing processing using a lightweight LLM (hereinafter also referred to as a second LLM or a second language model) that is lower in cost and faster than the first LLM.

The input assistance apparatus 100 includes an input unit 110, an analysis unit 120, a query candidate generation unit 130, a query candidate evaluation unit 140, an output unit 150, a knowledge base 160, and a history information storage unit 170.

The input unit 110 has a function of receiving input via a user interface. For example, the input unit 110 receives multi-modal input from a user via the user interface. Hereinafter, input from a user received by the input unit 110 is also referred to as user input. The user input includes, for example, information indicating an inquiry to a co-pilot or a virtual assistant (hereinafter also referred to as a query).

Multi-modal input is an input scheme capable of integratively processing multiple different formats of information. Specifically, it refers to processing a combination of various forms of data such as voice, images, video, and gestures in addition to text input. Accordingly, a user can select an optimal input method depending on a situation and a need. Further, the input assistance apparatus 100 can perform appropriate responses or processing based on more diverse information.

The input unit 110 has a function of inputting context information indicating a situation of the user. For example, the input unit 110 acquires and inputs context information when accepting a user input.

For example, the input unit 110 acquires, from the history information storage unit 170, history information related to the user input, and inputs the history information as context information. The history information includes, for example, information indicating a history of input and output performed between the user and the input assistance apparatus 100 (or a co-pilot or a virtual assistant), that is, a dialog history.

Further, for example, the input unit 110 acquires work state information indicating a work state of the user, work environment information indicating a work environment of the user, and the like, and inputs such information as context information. The work state information includes information indicating, for example, a work state or work content of the user. The work environment information includes information indicating, for example, a configuration of equipment or software used by the user.

The analysis unit 120 includes a user input analysis unit 121 for analyzing user input and a context analysis unit 122 for analyzing context information.

The user input analysis unit 121 has a function of analyzing user input using the second LLM. For example, the user input analysis unit 121 executes, using the second LLM, processing of detecting and correcting typos included in user input (hereinafter also referred to as typo correction processing). Further, the user input analysis unit 121 executes, using the second LLM, processing of determining whether user input has an issue in interpretability (hereinafter also referred to as interpretability determination processing).

In the interpretability determination processing, the user input analysis unit 121 executes, for example, processing of determining whether user input is ambiguous (hereinafter also referred to as ambiguity determination processing). When it is determined that the user input is ambiguous, the user input analysis unit 121 determines that the user input has an issue in interpretability. User input being ambiguous refers to, for example, a state in which multiple interpretations exist for the user input (or a keyword or a phrase included in the user input) and it is difficult to determine which interpretation is intended.

Further, in the interpretability determination processing, the user input analysis unit 121 executes, for example, processing of determining whether user input is clear (hereinafter also referred to as clarity determination processing). When it is determined that the user input is not clear, the user input analysis unit 121 determines that the user input has an issue in interpretability. User input being not clear refers to, for example, a state in which information included in the user input is insufficient and lacks specificity.

The interpretability determination processing may be configured to execute only one of the ambiguity determination processing and the clarity determination processing, or may be configured to execute both.

The user input analysis unit 121 can output, as an analysis result, a processing result of the typo correction processing and a processing result of the interpretability determination processing. For example, the user input analysis unit 121 outputs, as the processing result of the typo correction processing, user input (for example, a query) in which a typo has been corrected. Further, the user input analysis unit 121 outputs, as the processing result of the interpretability determination processing, True indicating that the user input has an issue in interpretability, or False indicating that the user input has no issue in interpretability.

The user input analysis unit 121 may be configured to have a function of identifying a keyword and a phrase included in user input and comparing the identified keyword and phrase with information stored in the knowledge base 160 of a relevant technical field. In this case, the user input analysis unit 121 can execute typo correction processing and interpretability determination processing based on a comparison result.

The context analysis unit 122 has a function of analyzing context information using the second LLM.

For example, the context analysis unit 122 analyzes input context information and generates information indicating a summary of an activity that is estimated to be currently performed by the user. Further, the context analysis unit 122 analyzes the input context information and generates a list (hereinafter also referred to as a prioritized term list) in which technical terms and tags that are estimated to be currently focused on by the user are arranged in order of priority. A technical term refers to, for example, a term used explicitly. In contrast, a tag includes not only a term used explicitly but also a term related to an associated theme or function that is estimated from the context. In the prioritized term list, for example, a term estimated to have higher current focus by the user is arranged with a higher priority based on the analysis result of the context.

The context analysis unit 122 may be configured to have a function of identifying a keyword and a phrase included in user input and comparing the identified keyword and phrase with information stored in the knowledge base 160 of a relevant technical field. In this case, the context analysis unit 122 can generate the prioritized term list based on the comparison result.

The query candidate generation unit 130 has a function of generating query candidates using the second LLM based on analysis results of the analysis unit 120, that is, analysis results of the user input analysis unit 121 and the context analysis unit 122.

For example, the query candidate generation unit 130 generates, using the second LLM, a plurality of query candidates having different focuses or different levels of detail, and outputs the query candidates in a list format of strings.

The query candidate evaluation unit 140 has a function of evaluating query candidates using the second LLM. For example, the query candidate evaluation unit 140 analyzes context information based on the generated query candidates and the prioritized term list, and ranks the query candidates based on the analysis result. At this time, the query candidate evaluation unit 140 evaluates the query candidates based on a degree of match with an estimated intent of the user, and ranks a query candidate having a higher degree of match higher.

The output unit 150 has a function of outputting information indicating query candidates (or query candidates and evaluation results thereof).

For example, the output unit 150 outputs, to a display device such as a display device (not illustrated), information indicating a plurality of query candidates arranged in descending order of rank. Further, the output unit 150 can output such information by voice via a speaker (not illustrated).

Further, the output unit 150 can output information indicating query candidates (or query candidates and evaluation results thereof) in different formats such as text, images, and voice in accordance with user settings. For example, the input assistance apparatus 100 may include a setting storage unit (not illustrated) that stores an output format set by the user as an output setting. In this case, the output unit 150 can output information indicating query candidates and evaluation results thereof in a predetermined format based on the output setting stored in the setting storage unit. Further, the output unit 150 can output and store information indicating query candidates and evaluation results thereof in a storage unit (not illustrated) of the input assistance apparatus 100 or an external apparatus.

In the present example embodiment, operation in which the output unit 150 outputs information indicating query candidates (or query candidates and evaluation results thereof) is also expressed as proposing query candidates to a user.

The output unit 150 has a function of outputting, to a co-pilot or a virtual assistant, a selected query based on selection by the user of any of the output query candidates. Further, the output unit 150 has a function of storing, in the history information storage unit 170 as history information, a dialog history with the user including selection of a query. Further, the output unit 150 may have a function of updating an output setting stored in the setting storage unit (not illustrated) based on the selected query candidate. For example, when the user performs an operation of selecting one of a plurality of query candidates displayed using a terminal apparatus, it is determined that one of the query candidates has been selected.

When it is determined by the query candidate evaluation unit 140 that none of the query candidates satisfies a predetermined condition, the output unit 150 can output, to the user, information indicating a request for providing additional information (hereinafter also referred to as a supplementary information request). The predetermined condition is, for example, that a query candidate is equal to or more than a predetermined threshold in a degree of match with an estimated intent of the user. When the user performs an input operation after output of the supplementary information request, processing by the analysis unit 120, the query candidate generation unit 130, and the query candidate evaluation unit 140 is executed again by reflecting user input based on the input operation.

The output unit 150 may be configured to output the supplementary information request when it is determined by the user input analysis unit 121 that user input has an issue in interpretability (or user input is not clear). Accordingly, after resolving the interpretability issue of the user input (or after clarifying the user input), processing by the query candidate generation unit 130 and the query candidate evaluation unit 140 can be executed.

The knowledge base 160 is a database that stores information in a computer-readable format. The knowledge base 160 systematically stores information such as terms, definitions, relationships, and examples in a predetermined technical field. The knowledge base 160 is used by the analysis unit 120 as an information source for accurately determining what meaning a keyword or a phrase included in user input has in the relevant technical field.

The knowledge base 160 may be configured to be provided separately for each specific technical field, or may be configured as a single knowledge base supporting a plurality of technical fields. Further, the knowledge base 160 may be provided outside the input assistance apparatus 100 and may be configured to be accessible from the input assistance apparatus 100 via a communication network such as the Internet.

The history information storage unit 170 stores, for each user, history information indicating a history of input and output performed between the user and the input assistance apparatus 100 (or a co-pilot or a virtual assistant), that is, a dialog history.

History information stored in the history information storage unit 170 includes information indicating, among query candidates proposed in the past by the input assistance apparatus 100, a result actually selected by the user. That is, information related to preference of the user is accumulated as history information. Because the input assistance apparatus 100 is configured to rank and propose query candidates using context information including such history information, it becomes possible to reflect preference of the user.

### Explanation of Operation

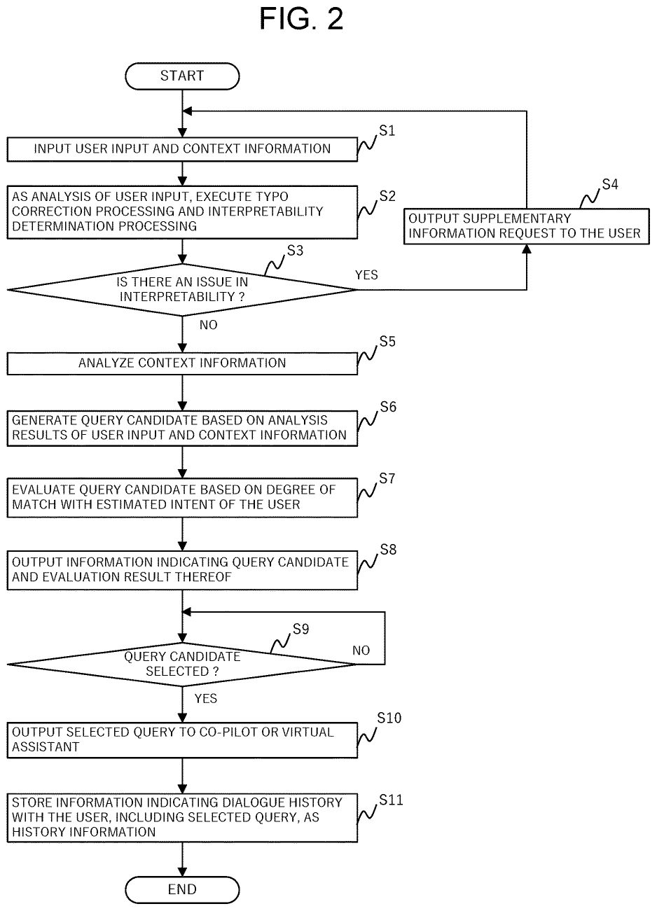

Next, operation of the input assistance apparatus is explained. FIG. 2 is a flowchart illustrating example operation of the input assistance apparatus 100.

The input unit 110 inputs user input and context information (Step S1).

Next, as analysis of user input, the user input analysis unit 121 executes typo correction processing and interpretability determination processing using the second LLM (Step S2).

Next, when it is determined that there is an issue in interpretability (Yes in Step S3), the output unit 150 outputs a supplementary information request to the user (Step S4). Thereafter, when input is received via the user interface, processing transitions to Step S1.

When it is determined that there is no issue in interpretability (No in Step S3), the context analysis unit 122 analyzes context information regarding the user using the second LLM (Step S5). For example, the context analysis unit 122 analyzes input context information and generates information indicating a summary of an activity that is estimated to be currently performed by the user. Further, the context analysis unit 122 analyzes the input context information and generates a prioritized term list in which technical terms and tags that are estimated to be currently focused on by the user are arranged in descending order of priority.

Next, the query candidate generation unit 130 generates query candidates using the second LLM based on analysis results of the user input analysis unit 121 and the context analysis unit 122 (Step S6). For example, the query candidate generation unit 130 generates, using the second LLM, a plurality of query candidates having different focuses or different levels of detail, and outputs the query candidates in a list format of strings.

Next, the query candidate evaluation unit 140 evaluates the query candidates using the second LLM (Step S7). For example, the query candidate evaluation unit 140 analyzes context information based on the generated query candidates and the prioritized term list, and ranks the query candidates based on the analysis result. At this time, the query candidate evaluation unit 140 evaluates the query candidates based on a degree of match with an estimated intent of the user, and ranks a query candidate having a higher degree of match higher.

Next, the output unit 150 outputs information indicating the query candidates and evaluation results thereof (Step S8). For example, the output unit 150 outputs, to a display device such as a display device (not illustrated), information indicating a plurality of query candidates arranged in descending order of rank.

Next, when any of the output query candidates is selected by the user (Yes in Step S9), the output unit 150 outputs the selected query to a co-pilot or a virtual assistant (Step S10).

Next, the output unit 150 stores, in the history information storage unit 170 as history information, information indicating a dialog history with the user including the selected query (Step S11).

The example operation illustrated in FIG. 2 does not limit operation of the input assistance apparatus 100 according to the present disclosure. For example, the input assistance apparatus 100 may be configured to execute processing of Steps S2, S3, and S6 in parallel, or may be configured to execute processing of Steps S9 and S10 in parallel. Further, when it is determined by the query candidate evaluation unit 140 that none of the query candidates satisfies a predetermined condition, the input assistance apparatus 100 may be configured to transition to Step S4 and output a supplementary information request to the user. In this case, processing of Step S3 may be omitted.

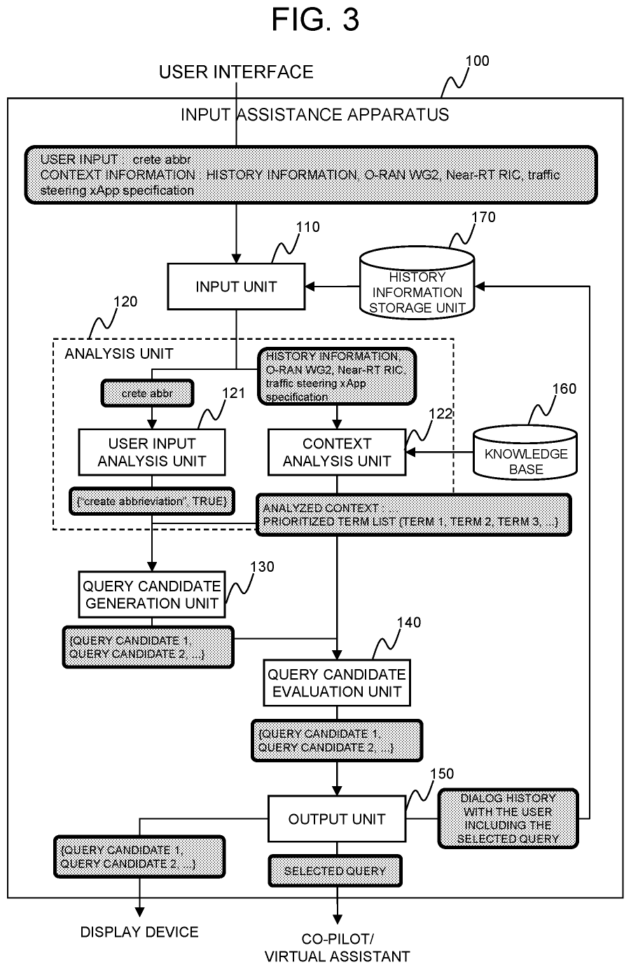

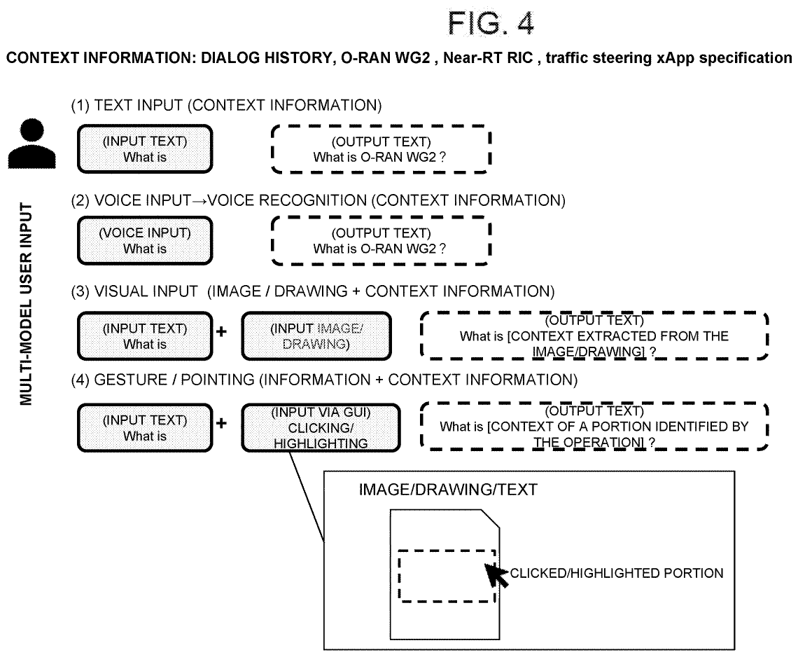

Next, an operation overview of the input assistance apparatus 100 is explained with reference to FIG. 3 and FIG. 4. FIG. 3 and FIG. 4 are explanatory diagrams for facilitating understanding of the operation overview of the input assistance apparatus 100. Accordingly, configuration and operation of the input assistance apparatus 100 are not limited to those illustrated in FIG. 3 and FIG. 4. Further, arrows in FIG. 3 succinctly indicate a direction of signal (data) flow, but do not exclude bidirectionality. The same applies to other drawings.

FIG. 3 illustrates an example in which the input unit 110 inputs, as user input, a string “crete abbr” and inputs, as context information, history information (dialog history) and work state information (“O-RAN WG2”, “Near-RT RIC”, and “traffic steering xApp specification”).

O-RAN WG2(Open Radio Access Network Working Group 2) refers to a working group of an organization that promotes standardization of an open radio access network (RAN). Near-RT RIC (Near-Real-Time RAN Intelligent Controller) refers to a component that controls a network in near-real time in an O-RAN architecture. A traffic steering xApp specification refers to specifications of design and operation of an xApp that achieves traffic steering. In the example illustrated in FIG. 3, such information is work state information indicating a work state or work content of the user.

As analysis of user input, the user input analysis unit 121 executes typo correction processing and interpretability determination processing using the second LLM. Inference settings in the second LLM in this case are, for example, as follows.

### Instructions

(1) Detect and correct a typo included in user input.
(2) Determine interpretability of user input, and return the determination result as True (interpretability has an issue) or False (interpretability has no issue).

### Response: {“corrected input”, True or False}

In the example illustrated in FIG. 3, the user input analysis unit 121 inputs user input “crete abbr” and outputs, as an analysis result, {“create abbrieviation”, True}. That is, the user input analysis unit 121 determines that a user incorrectly input “crete abbr” although the user should have input “create abbrieviation” (create an abbreviation), and appropriately corrects it. Further, the user input analysis unit 121 determines that both “crete abbr” before correction and “create abbrieviation” after correction have an issue in interpretability, and outputs the analysis result as True (interpretability has an issue).

The context analysis unit 122 analyzes context information using the second LLM. Inference settings in the second LLM in this case are, for example, as follows.

### Instructions

(1) Analyze context information and generate information indicating a summary of an activity that is estimated to be currently performed by the user.
(2) Generate a prioritized term list in which technical terms and tags that are estimated to be currently focused on by the user are arranged in order of priority. In the prioritized term list, terms are arranged in descending order of priority based on an analysis result of the context information.

In the example illustrated in FIG. 3, the context analysis unit 122 inputs, as context information, history information (dialog history) and work state information (“O-RAN WG2”, “Near-RT RIC”, and “traffic steering xApp specification”), and outputs an analysis result of the context information {Analyzed contexts: “. . . ”} and a prioritized term list {term 1, term 2, term 3, . . . }.

The query candidate generation unit 130 generates query candidates using the second LLM based on analysis results of the user input analysis unit 121 and the context analysis unit 122. Inference settings in the second LLM in this case are, for example, as follows.

Instructions:
(1) Using, as input, a query of user input (or a query after typo correction) and an analysis result of context information, analyze both in order to accurately understand current work content and technical interest of the user (that is, an intent of the user).
(2) Identify main technical terms, tags, and project-specific information related to the query.
(3) Supplement missing information and relevant context to expand and clarify the query.
(4) Appropriately rephrase ambiguous or unclear expressions included in the query in such a way that an intent of the user is conveyed accurately and clearly.
(5) Optimize each expanded query in a detailed, clear, and context-appropriate form, and include all information necessary for a large language model (the first LLM) to process effectively.
(6) Generate a plurality of query proposals having different focuses or different levels of detail, and output the proposals in a list format of strings.

In the example illustrated in FIG. 3, the query candidate generation unit 130 inputs an analysis result of user input {“create abbrieviation”, True} and an analysis result of context information {Analyzed contexts: “. . . ”}, and outputs query candidates {query candidate 1, query candidate 2, . . . }.

The query candidate evaluation unit 140 analyzes context information based on query candidates and the prioritized term list using the second LLM, and ranks the query candidates based on the analysis result. At this time, the query candidate evaluation unit 140 evaluates the query candidates based on a degree of match with an estimated intent of the user, and evaluates a query candidate having a higher degree of match higher. Inference settings in the second LLM in this case are, for example, as follows.

### Instructions

(1) Analyze context information based on the query candidates and the prioritized term list.
(2) Evaluate the query candidates based on a degree of match with an estimated intent of the user, and rank a query candidate having a higher degree of match higher.

In the example illustrated in FIG. 3, the query candidate evaluation unit 140 inputs query candidates {query candidate 1, query candidate 2, . . . } and a prioritized term list {term 1, term 2, term 3, . . . }, and outputs, as an evaluation result, ranked query candidates {query candidate 2, query candidate 1, . . . }. Here, query candidate 2 is evaluated as having a higher degree of match with an estimated intent of the user than query candidate 1.

The output unit 150 outputs the ranked query candidates {query candidate 2, query candidate 1, . . . } to a display device such as a display device. Accordingly, the input assistance apparatus 100 proposes query candidates to the user.

Further, based on selection by the user of any of the output query candidates, the output unit 150 outputs the selected query to a co-pilot or a virtual assistant. Further, the output unit 150 stores, in the history information storage unit 170 as history information, a dialog history with the user including the selected query.

A specific example of output query candidates is described below. For example, assume a case in which user input (a query) is “create abbreviation” and context information includes operation information indicating an operation situation that “a user highlights text related to a design specification in an IDE”.

In this case, the analysis unit 120 dynamically analyzes user input and context information based on a context of the highlighted text and generates the prioritized term list. Based on the analysis result, the query candidate generation unit 130 generates query candidate 1 and query candidate 2 that match an intent of the user and have less ambiguity. The query candidate evaluation unit 140 evaluates each query candidate based on the prioritized term list and evaluates query candidate 2, which has a higher degree of match with the intent of the user, higher. As a result, the output unit 150 outputs, as ranked query candidates, information such as the following.
Query candidate 2:“Create an abbreviation of the highlighted text in the traffic steering xApp specification.”
Query candidate 1:“Create an abbreviation of Near-RT RIC.”

In this way, by using dynamic context information such as highlighted text, the input assistance apparatus 100 can achieve input assistance that accurately reflects an intent of the user.

When it is determined by the query candidate evaluation unit 140 that none of the query candidates satisfies a predetermined condition, or when it is determined by the user input analysis unit 121 that user input has an issue in interpretability (or user input is not clear), a supplementary information request for requesting provision of supplementary information is output to the user. The supplementary information request is presented as an interactive question for clarifying an intent of the user. For example, a message such as the following may be output. “Do you mean creating an abbreviation of the traffic steering xApp specification, or creating an abbreviation of O-RAN WG2?”

In this way, the input assistance apparatus 100 includes a user engagement mechanism for clarifying or reconstructing user input (a query) through dialog with the user. With this mechanism, it becomes possible to propose query candidates that match an intent of the user and have less ambiguity.

FIG. 4 is a diagram illustrating an example operation overview for multi-modal user input. FIG. 4 illustrates an example of inputting, as context information, history information (dialog history) and work state information (“O-RAN WG2”, “Near-RT RIC”, and “traffic steering xApp specification”).

FIG. 4(1) illustrates an example in which text “What is” is input as user input and text “What is O-RAN WG2?” is output as a query candidate based on an analysis result of context information.

FIG. 4(2) illustrates an example in which voice “What is” is input as user input. In this case, the analysis unit 120 executes speech recognition processing for the input voice data to convert it into text “What is”. Then, the input assistance apparatus 100 outputs text “What is O-RAN WG2?” as a query candidate based on the analysis result of context information.

FIG. 4(3) illustrates an example in which, in addition to text “What is”, an image or a drawing is input as user input. In this case, the context analysis unit 122 analyzes the input image or drawing as context information. Then, based on the analysis result of context information including the image or drawing, the input assistance apparatus 100 outputs, for example, a query candidate (text) “What is [context extracted from the image or the drawing]?”. In query candidates, the portion [context extracted from the image or the drawing] is filled with a string indicating information obtained by analyzing the image or the drawing.

FIG. 4(4) illustrates an example in which, in addition to text “What is”, operation information indicating operations such as clicking or highlighting an image, a drawing, or text on a graphical user interface (GUI: Graphical User Interface) is input as user input. In this case, the context analysis unit 122 analyzes the input operation information as context information. Then, based on the analysis result of context information including the operation information, the input assistance apparatus 100 outputs, for example, a query candidate (text) “What is [context of a portion identified by the operation]?”. In query candidates, the portion [context of a portion identified by the operation] is filled with a string indicating information obtained by analyzing the portion identified by the operation information.

### Explanation of Effects

Next, effects of the present example embodiment are explained. In the present example embodiment, the input unit 110 inputs user input to a task assistance application such as a co-pilot or a virtual assistant built on the first LLM and context information indicating a situation of the user. Using the second LLM, which is a lightweight LLM that is lower in cost and faster than the first LLM, the user input analysis unit 121 analyzes the user input, corrects a typo included in the user input, and determines interpretability of the user input. Using the second LLM, the context analysis unit 122 analyzes the context information and generates information indicating a summary of an activity that is estimated to be currently performed by the user and a prioritized term list including technical terms or tags that are estimated to be currently focused on by the user. Based on analysis results of the user input and the context information, the query candidate generation unit 130 generates a plurality of query candidates using the second LLM. Using the second LLM, the query candidate evaluation unit 140 evaluates the query candidates based on a degree of match with an intent of the user. The output unit 150 outputs information indicating the query candidates and evaluation results thereof. The history information storage unit 170 stores history information indicating selection results by the user for the output query candidates. The input unit 110 inputs, as context information, the history information stored in the history information storage unit 170.

With such a configuration, because the input assistance apparatus 100 generates and evaluates query candidates based on dynamic context information, it can accurately reflect an intent of the user and can improve accuracy of input assistance.

The input assistance apparatus 100 according to the present disclosure has features as follows.

Dynamic input optimization: The input assistance apparatus 100 continuously analyzes and optimizes user input in real time and proposes generated query candidates by addressing technical issues such as real-time latency management, dynamic context analysis, and consistency with an intent of the user. Accordingly, it becomes possible to perform dialog consistent with an intent with a task assistance application such as a co-pilot.

Further, the input assistance apparatus 100 according to the present disclosure also has features as follows.
(1) Real-time latency management: Because the input assistance apparatus 100 employs a lightweight architecture, it can promptly process user input and dynamic context information with low latency even under resource constraints.
(2) Dynamic context processing: The input assistance apparatus 100 continuously monitors changes in user behavior (for example, dialog history, text selected in an IDE, data of an external API (Application Programming Interface), and the like). Based on such information, the input assistance apparatus 100 can dynamically prioritize context and reflect information effective for optimization of user input.
(3) Multi-modal context understanding: Using a lightweight LLM (for example, GPT-o4-mini (Generative Pre-trained Transformer-o4-mini)), the input assistance apparatus 100 processes, in real time, various context information such as text, API outputs, and IDE signals. Accordingly, limitations of static context use are overcome, and the input assistance apparatus 100 enables continuous updating of context information without recomputation.
(4) Iterative improvement with feedback loop: Through a feedback loop based on user behavior and dialog history, the input assistance apparatus 100 can iteratively improve an optimization strategy, adapt to preference of the user over time, and improve quality of proposals and improvements.
(5) User-participatory optimization: In complex or ambiguous scenarios, the input assistance apparatus 100 allows the user to fine-tune or override the generated query candidates. Accordingly, the input assistance apparatus 100 can provide optimal assistance while balancing automation by the input assistance apparatus 100 and determination by the user.
(6) Cost-efficient dialog with a co-pilot: By optimizing input to a high-cost first LLM (for example, GPT-o1) using a lightweight second LLM (for example, GPT-o4-mini), the input assistance apparatus 100 suppresses resource consumption while maintaining response quality.

Each function (each processing) in the example embodiment described above can be implemented by a computer having a processor, a memory, and the like. For example, a program for implementing the method (processing) in the example embodiment described above is stored in a storage device (storage medium), and each function may be implemented by executing, by a processor, the program stored in the storage device.

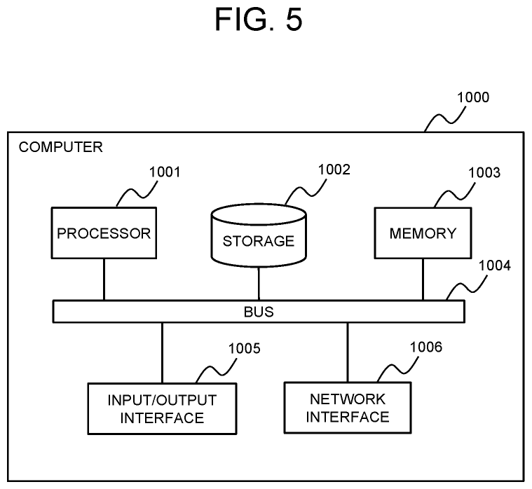

FIG. 5 is a block diagram illustrating an example hardware configuration of a computer 1000. The computer 1000 is an arbitrary computer. For example, the computer 1000 is a stationary computer such as a personal computer or a server machine. Further, for example, the computer 1000 is a portable computer such as a smartphone or a tablet terminal. The computer 1000 may be a dedicated computer designed to implement the input assistance apparatus 100 or may be a general-purpose computer.

The computer 1000 includes a processor 1001, a storage device 1002, a memory 1003, a bus 1004, an input and output interface 1005, and a network interface 1006.

The processor 1001 is various processing devices such as a CPU (Central Processing Unit), a GPU (Graphics Processing Unit), an FPGA (Field-Programmable Gate Array), and a DSP (Digital Signal Processor).

The storage device 1002 is, for example, a non-transitory computer-readable medium. The non-transitory computer-readable medium includes various types of tangible storage media. Specific examples of the non-transitory computer-readable medium include semiconductor memories such as a mask ROM, a PROM (Programmable ROM), an EPROM (Erasable PROM), and a flash ROM.

The memory 1003 is a main storage device implemented using a RAM (Random Access Memory) or the like. The memory 1003 temporarily stores data when the processor 1001 executes processing.

The bus 1004 is a data transmission path for the processor 1001, the memory 1003, the storage device 1002, the input and output interface 1005, and the network interface 1006 to transmit and receive data with each other. However, a method of connecting components such as the processor 1001 is not limited to bus connection.

The input and output interface 1005 is an interface for connecting the computer 1000 to an input and output device. For example, an input device such as a keyboard and an output device such as a display device are connected to the input and output interface 1005.

The network interface 1006 is an interface for connecting the computer 1000 to a network. This network may be a LAN (Local Area Network) or may be a WAN (Wide Area Network).

The storage device 1002 stores a program for implementing each functional component in the example embodiments and examples described above. By reading this program into the memory 1003 and executing it, the processor 1001 implements each functional component in the example embodiments and examples described above.

The input assistance apparatus 100 may be implemented by one computer 1000 or may be implemented by a plurality of computers 1000. In the latter case, configurations of the computers 1000 are not required to be identical and may be different from each other.

Each functional component in the example embodiments and examples described above may be implemented by a combination of hardware and software described above or may be implemented by hardware (for example, a hardwired electronic circuit).

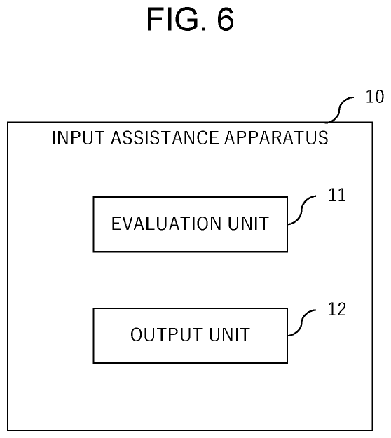

Next, an overview of the present disclosure is explained. FIG. 6 is a block diagram illustrating an overview of an input assistance apparatus. An input assistance apparatus 10 according to the present disclosure (for example, corresponding to the input assistance apparatus 100) includes evaluation unit 11 (which in the embodiment is realized by the query candidate evaluation unit 140) configured to evaluate, using a second language model (for example, the second LLM) that is lighter than a first language model (for example, the first LLM), a query candidate generated based on analysis results of input information (for example, user input (a query)) indicating input from a user to a task assistance application (for example, a co-pilot or a virtual assistant) built on the first language model and context information indicating a situation of the user, based on a degree of match with an intent of the user, and output unit 12 (which in the embodiment is realized by the output unit 150) configured to output information indicating the query candidate and an evaluation result thereof. With such a configuration, it becomes possible to accurately reflect an intent of the user and improve accuracy of input assistance.

While the present disclosure has been explained with reference to the example embodiments, the present disclosure is not limited to the example embodiments described above. Various changes that may be understood by a person skilled in the art can be made to configuration and details of the present disclosure within the scope of the present disclosure. Each example embodiment can be combined with another example embodiment as appropriate.

Each drawing is merely an example for explaining one or more example embodiments. Each drawing is not associated only with one specific example embodiment and may be associated with one or more other example embodiments. As will be understood by a person skilled in the art, various features or steps explained with reference to any one drawing can be combined with features or steps illustrated in one or more other drawings, for example, in order to create an example embodiment that is not explicitly illustrated or explained. Not all features or steps illustrated in any one drawing are necessarily essential for explaining an example embodiment, and some features or steps may be omitted. An order of steps described in any drawing may be changed as appropriate.

Some or all of the example embodiments described above can also be described as Supplementary note(s) below, but the present disclosure is not limited to the following.

### Supplementary Note 1

An input assistance apparatus comprising:
an evaluation unit configured to evaluate, using a second language model that is lighter than a first language model, a query candidate generated based on analysis results of input information indicating input from a user to a task assistance application built on the first language model and context information indicating a situation of the user, based on a degree of match with an intent of the user; and
an output unit configured to output information indicating the query candidate and an evaluation result thereof.

### Supplementary Note 2

The input assistance apparatus according to Supplementary note 1, further comprising
a context information analysis unit configured to analyze the context information using the second language model and generate information indicating a summary of an activity that is estimated to be currently performed by the user and a term list including technical terms or tags that are estimated to be currently focused on by the user, wherein
the evaluation unit evaluates the query candidate based on the analysis result of the context information including the term list.

### Supplementary note 3

The input assistance apparatus according to Supplementary note 2, wherein
the context information analysis unit generates the term list in which the technical terms or the tags are arranged in descending order of priority based on the analysis result of the context information.

### Supplementary Note 4

The input assistance apparatus according to any one of Supplementary note 1 to Supplementary note 3, further comprising
an input information analysis unit configured to analyze the input information using the second language model, correct a typo of the input information, and determine interpretability of the input information.

### Supplementary Note 5

The input assistance apparatus according to any one of Supplementary note 1 to Supplementary note 4, further comprising
a generation unit configured to generate a plurality of query candidates using the second language model based on analysis results of the input information and the context information, wherein
the output unit outputs information indicating the plurality of query candidates arranged in descending order of evaluation by the evaluation unit.

### Supplementary Note 6

The input assistance apparatus according to Supplementary note 5, wherein
the generation unit generates the query candidates using technical terms related to the input information.

### Supplementary Note 7

The input assistance apparatus according to any one of Supplementary note 1 to Supplementary note 6, further comprising
a storage unit configured to store, as the context information, history information indicating a selection result by the user for the query candidate output by the output unit.

### Supplementary Note 8

The input assistance apparatus according to any one of Supplementary note 1 to Supplementary note 7, wherein
the output unit outputs information indicating the query candidate and the evaluation result thereof based on an output format that can be set by the user.

### Supplementary Note 9

An input assistance method, performed by a computer and comprising:
evaluating, by a computer using a second language model that is lighter than a first language model, a query candidate generated based on analysis results of input information indicating input from a user to a task assistance application built on the first language model and context information indicating a situation of the user, based on a degree of match with an intent of the user; and
outputting information indicating the query candidate and an evaluation result thereof.

### Supplementary Note 10

An input assistance program for causing a computer to execute:
evaluation processing for evaluating, using a second language model that is lighter than a first language model, a query candidate generated based on analysis results of input information indicating input from a user to a task assistance application built on the first language model and context information indicating a situation of the user, based on a degree of match with an intent of the user; and
output processing for outputting information indicating the query candidate and an evaluation result thereof.

### Supplementary Note 11

A non-transitory computer readable recording medium storing an input assistance program which, when executed by a processor, performs:
evaluating, by a computer using a second language model that is lighter than a first language model, a query candidate generated based on analysis results of input information indicating input from a user to a task assistance application built on the first language model and context information indicating a situation of the user, based on a degree of match with an intent of the user; and
outputting information indicating the query candidate and an evaluation result thereof.

Further, some or all of the configurations described in Supplementary note 2 to Supplementary note 8, which depend on Supplementary note 1, can also depend on Supplementary note 9, Supplementary note 10, and Supplementary note 11 with the same dependency relationships as Supplementary note 2 to Supplementary note 8. Further, not only Supplementary note 1, Supplementary note 9, Supplementary note 10, and Supplementary note 11, but also, within a range not departing from the example embodiments described above, for various hardware, software, various recording means for recording software, or systems, some or all of the configurations described as Supplementary note(s) can similarly be made dependent.

1. An input assistance apparatus comprising:
a memory storing software instructions; and
one or more processors configured to execute the software instructions to:
evaluate, using a second language model that is lighter than a first language model, a query candidate generated based on analysis results of input information indicating input from a user to a task assistance application built on the first language model and context information indicating a situation of the user, based on a degree of match with an intent of the user; and
output information indicating the query candidate and an evaluation result thereof.

2. The input assistance apparatus according to claim 1, wherein the one or more processors are further configured to execute the software instructions to
analyze the context information using the second language model and generate information indicating a summary of an activity that is estimated to be currently performed by the user and a term list including technical terms or tags that are estimated to be currently focused on by the user, wherein
the one or more processors evaluate the query candidate based on the analysis result of the context information including the term list.

3. The input assistance apparatus according to claim 2, wherein
the one or more processors generate the term list in which the technical terms or the tags are arranged in descending order of priority based on the analysis result of the context information.

4. The input assistance apparatus according to claim 1, wherein the one or more processors are further configured to execute the software instructions to
analyze the input information using the second language model, correct a typo of the input information, and determine interpretability of the input information.

5. The input assistance apparatus according to claim 1, wherein the one or more processors are further configured to execute the software instructions to
generate a plurality of query candidates using the second language model based on analysis results of the input information and the context information, wherein
the one or more processors output information indicating the plurality of query candidates arranged in descending order of evaluation.

6. The input assistance apparatus according to claim 5, wherein
the one or more processors generate the query candidates using technical terms related to the input information.

7. The input assistance apparatus according to claim 1, further comprising
a storage unit configured to store, as the context information, history information indicating a selection result by the user for the query candidate output.

8. The input assistance apparatus according to claim 1, wherein
the one or more processors output information indicating the query candidate and the evaluation result thereof based on an output format that can be set by the user.

9. An input assistance method, performed by a computer and comprising:
evaluating, using a second language model that is lighter than a first language model, a query candidate generated based on analysis results of input information indicating input from a user to a task assistance application built on the first language model and context information indicating a situation of the user, based on a degree of match with an intent of the user; and
outputting information indicating the query candidate and an evaluation result thereof.

10. A non-transitory computer readable medium storing an input assistance program which, when executed by a processor, performs:
evaluating, using a second language model that is lighter than a first language model, a query candidate generated based on analysis results of input information indicating input from a user to a task assistance application built on the first language model and context information indicating a situation of the user, based on a degree of match with an intent of the user; and
outputting information indicating the query candidate and an evaluation result thereof.

11. The input assistance apparatus according to claim 2, wherein the one or more processors are further configured to execute the software instructions to
analyze the input information using the second language model, correct a typo of the input information, and determine interpretability of the input information.

12. The input assistance apparatus according to claim 3, wherein the one or more processors are further configured to execute the software instructions to
analyze the input information using the second language model, correct a typo of the input information, and determine interpretability of the input information.

13. The input assistance apparatus according to claim 2, wherein the one or more processors are further configured to execute the software instructions to
generate a plurality of query candidates using the second language model based on analysis results of the input information and the context information, wherein
the one or more processors output information indicating the plurality of query candidates arranged in descending order of evaluation.

14. The input assistance apparatus according to claim 3, wherein the one or more processors are further configured to execute the software instructions to
generate a plurality of query candidates using the second language model based on analysis results of the input information and the context information, wherein
the one or more processors output information indicating the plurality of query candidates arranged in descending order of evaluation.

15. The input assistance apparatus according to claim 13, wherein
the one or more processors generate the query candidates using technical terms related to the input information.

16. The input assistance apparatus according to claim 14, wherein
the one or more processors generate the query candidates using technical terms related to the input information.
